(19) United States
(12) Patent Application Publication
(10) Pub. No.: US 2012/0200023 A1
(43) Pub. Date: Aug. 9, 2012

(54) CLAMPING DEVICE FOR A SHAFT AND METHOD FOR CLAMPING SAME

(76) Inventor: Tim Oberdalhoff, Lienen (DE)

(21) Appl. No.: 13/503,041

(22) PCT Filed: Nov. 10, 2010
(86) PCT No.: PCT/EP2010/067238

§ 371 Date: Apr. 20, 2012

(30) Foreign Application Priority Data
Nov. 10, 2009 (DE) 10 2009 052 411.8

(51) Int. Cl. B25B 5/06

(52) U.S. Cl. 269/216; 29/428

(57) ABSTRACT

A device and a method for holding a shaft (8), preferably a winding shaft (8), are described and applied for.

In order to hold the shaft (8) it (8) is fixated in an accept (3), by at least one body (3) being made to contact in the direction towards the shaft (8).

It is considered novel and inventive that a lever (5), which is supported rotational about a first axis (9), is moved in reference to the shaft.

The invention relates to a clamping device for a shaft and a method for clamping thereof. The device and method can firstly be used in any fields of technology. However, they are particularly suitable for storing and holding winding shafts. Here, the winding shaft train is a particular place of application.

In order to hold winding shafts at one side in the winding shaft train, clamping sockets with high clamping force are required.

For this purpose, prior art uses e.g., wedge-hook sockets, which are operated hydraulically and/or with very large pneumatic cylinders.

Alternatively, clamping device are used which are closed by motor-force using spindles.

### DISADVANTAGES

Wedge-hook sockets may apply strong clamping forces, however they only show a short stroke. Furthermore, they are very expensive.

When they are operated hydraulically, a hydraulic aggregate is required as well. Additionally, hydraulic aggregates are not very welcome in the production of e.g., food films, which are wound onto the respective winding device.

The large pneumatic cylinders used alternatively are very expensive.

When using clamping devices with spindle drives, although here large displacement paths are given, however at standard construction size their clamping force is relatively low. Another problem here is the wear and tear of the spindle drives caused by to the use and opening of the clamping device due to friction.

The objective of the present invention is therefore to suggest a device which corrects the described disadvantages of the device of prior art or at least reduces them.

According to the invention this objective is attained in the features of claim 1. Accordingly the device comprises a lever, which is supported rotational about an axis. By this measure, the forces can be increased and it is possible to yield a wide range of adjustment.

A locally fixed positioning and/or a first axis is advantageous, extending parallel in reference to the holding position of the shaft to be held in its socket.

It is particularly advantageous to provide a device for defining a second rotary axis, by which the second rotary axis can be defined for the lever, as needed. This device also comprises components necessary to quasi switch on a second rotary axis to the lever (“switchable additional rotary axis”). This may occur by a body, showing a round and/or curved surface, is made to contact the lever with said surface.

Alternatively or additionally a bore or recess may be provided in the lever, engaging a body which then defines the second axis.

In particular with regards to the second axis it may occur that no considerable rotary motion occurs with regards to its extent about the second axis, rather that it only serves to create leverage, by which adequate clamping forces can be applied.

Stops may be provided, which in turn may be mobile. When they can be fixed in the effective range of the lever, they may influence the pivotal motion that can be performed by said lever. It is advantageous for the lever to be pressed against a clamping jaw, which in turn fixates the shaft.

In the embodiment of the method according to the invention it is advantageous for the lever, which is supported pivotal about a first axis, to be moved in reference to the shaft. Generally, when fixating the shaft the lever is moved towards it and when the shaft is released again the lever is moved away. Prior to performing the rotary motion about the lever, said lever can perform a linear motion in reference to the shaft.

Additional exemplary embodiments of the invention are discernible from the description of the figures and the claims.

The individual figures show:

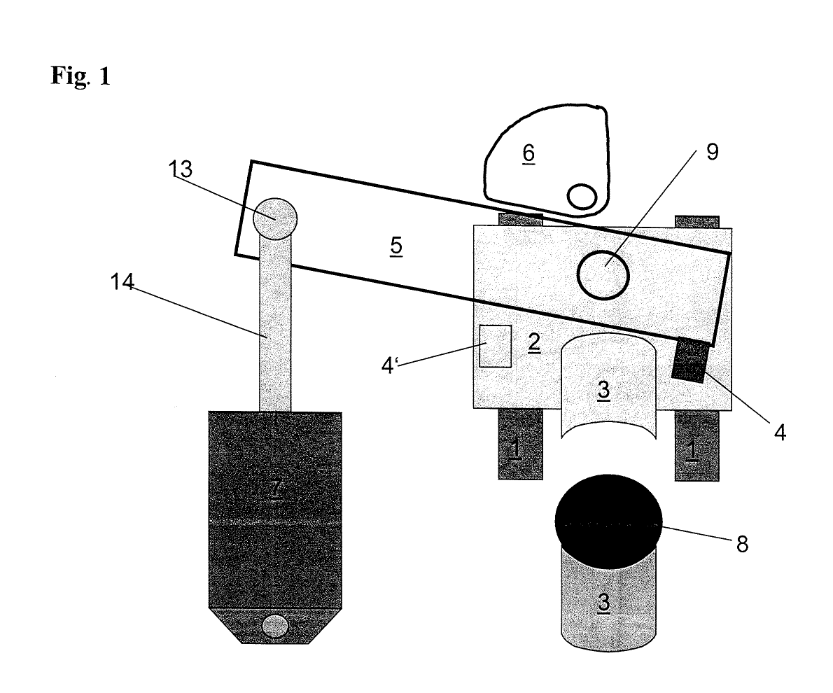

FIG. 1 An illustration of a device according to the invention in a first operating position

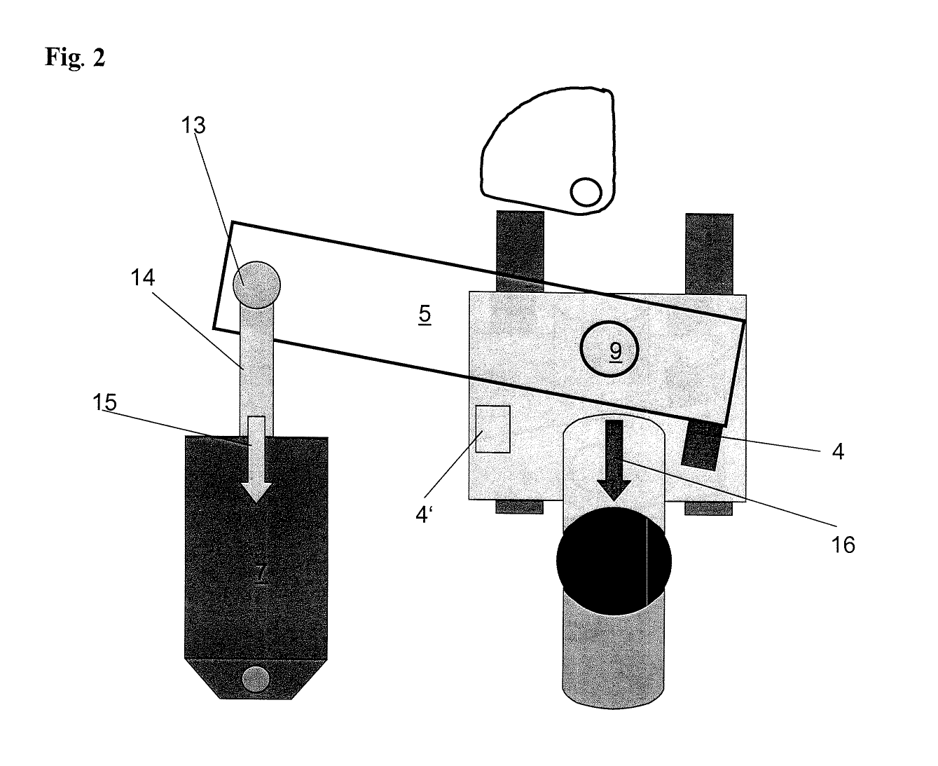

FIG. 2 An illustration of a device according to the invention of FIG. 1 in a second operating position

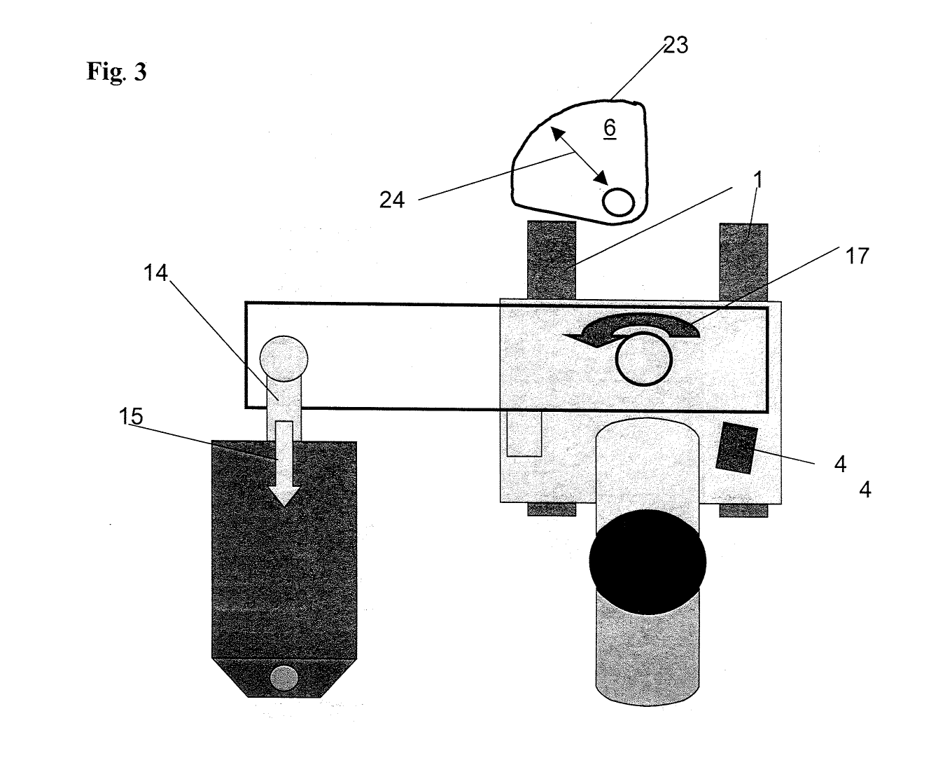

FIG. 3 An illustration of a device according to the invention of FIG. 1 in a third operating position

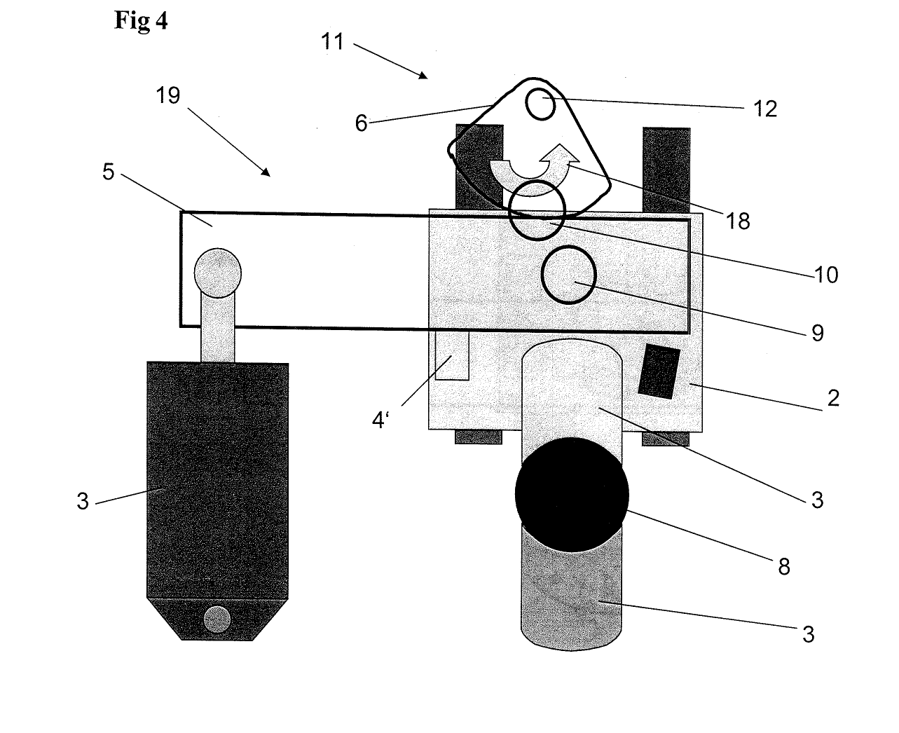

FIG. 4 An illustration of a device according to the invention of FIG. 1 in a fourth operating position

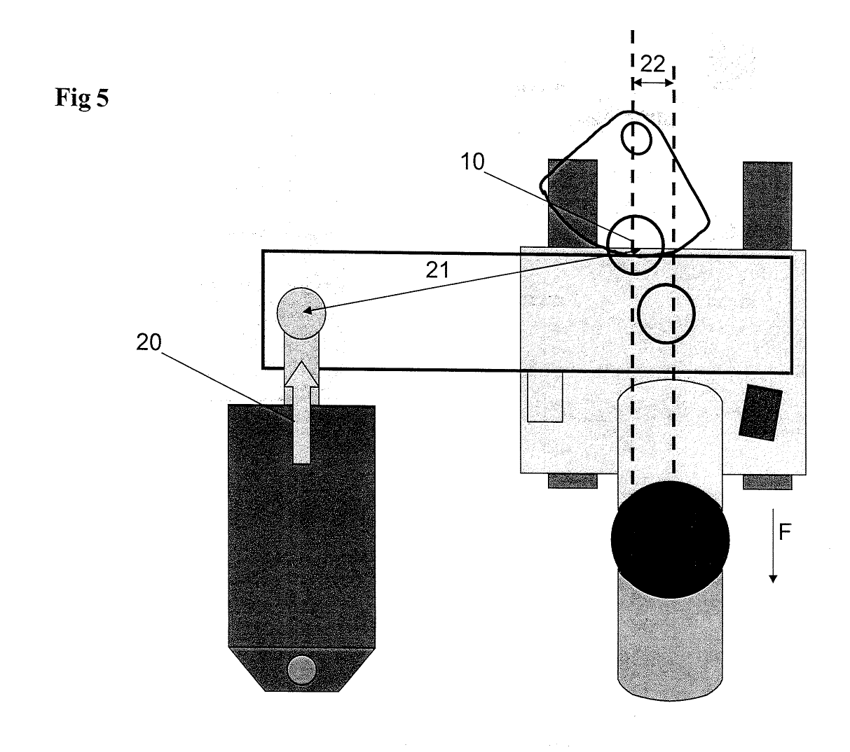

FIG. 5 An illustration of the device according to the invention of FIG. 1 in the fourth operating position, already shown in FIG. 4, with additional arrows being sketched in.

FIG. 1 shows an illustration of the device according to the invention in a first operating position, in which the shaft 8 is located in the recess 3, without being held, here. Rails 1 are provided in the clamping device 19, on which the sled 2 can glide back and forth in the vertical direction. Using this sled, the stops 4, the clamping jaw 3, and the first axis 10 of the lever 5 are mobile. Long opening paths can be yielded in the device shown when appropriately long rails 1 of this type are used. The lever 5 can be subjected to an operating power by the cylinder 7, which preferably represents a pneumatic cylinder, via the piston 14 and the link 13 of the piston.

It is already discernible in FIG. 2 how the piston 14 of the cylinder 7 is inserted into the cylinder (arrow 15). Here, the motion of the sled 2 develops, indicated by the arrow 16, by which the clamping jaw 3 is made to contact the shaft 8. FIG. 3 shows how the situation in the cylinder 8 changes by the continuous motion of the piston 14 indicated by the arrow 15: After the translation of the sled has come to an end, because the clamping jaw 3 has reached the shaft, a minor additional rotation occurs, indicated by the arrow 17, about the first axis 9 until the lever 5 reaches the left stop 4′. The clamping forces upon the shaft 8 that can be created in this situation are limited, though, due to the lever ratio.

In this situation, the clamping disk 6 is pivoted about the axis 12 into an operating position, as indicated by the arrow 18. Here, a second rotary axis 10 is defined, shown by the circle 10 and the [circle] 10 would move along the contact surface between the two bodies 5, 6 by the rolling motion of the lever 5 at the cam 6. In the present exemplary embodiment, here the lever 5, the clamping jaw 6, and its link 12 form the device to define a rotary axis 11. The link 12 is generally mounted in a fixed manner at the machine frame of the winding device and withstands large forces.

However, in the present exemplary embodiment no extensive motions are intended, rather the introduction of the second rotary axis 10 leads to a significant change of the lever ratios in reference to the situation in FIG. 3. Due to this circumstance the winding roll 8 is clamped with a strong force when the piston 14 moves back out of the cylinder 7, as indicated by the arrow 20 in FIG. 5. The forces are based on the distance 21 between the second rotary axis 10 and the linking point 14 as well as the distance 22 of the second rotary axis 10 and the first axis 9 orthogonally in reference to the effective direction of the force F.

In order to release the shaft 8 the processes occur in the inverse sequence. For reasons of illustration, the lever 5 located in front of the sled 2 is shown clear, thus without any colored areas, while components, such as the sled, are shown with colored areas.

Summarizing the following can be stated with regards to the embodiment of the clamping device 19 described:

Large displacement paths with strong clamping forces are yielded with a relatively small pneumatic drive (cylinder 7) in the clamping device 19 shown.

Here, this clamping device 19 uses the following circumstances:
1. Firstly, large displacement paths are yielded to close and/or open the clamping device via a simple displacement of the pneumatic cylinder (FIGS. 1 through 3).
2. Then strong clamping forces are yielded by “adding or guiding thereto” an additional rotary point 10 and the lever ratios resulting therefrom.

The advantages of the device 19 therefore include:
strong clamping forces can be yielded;
large displacement paths can be yielded;
small pneumatic drives 7 can be used (e.g., small adjustment paths);
by the additional rotary point 10 a mechanic safety against opening the clamping device 19 is given in case of a loss of energy supply;
the device 19 can be produced in a relatively cost-effective manner.

Additional advantages can be achieved when the incline of the cam is varied at its circumferential area 23. When this incline is minor, e.g., immediately in the proximity of the point at which the shaft 8 is fixed (frequently at the point where the distance of the circumferential area 23 from the point of rotation 12 of the cam 6 is greatest, preferably smallest in reference to the other circumferential areas), a strong closing force can be achieved with the cam as well.

### List of Reference Characters

1 Guiding Rails

2 Guiding Sled

3 Clamping Jaw/Accept for the Shaft 8

4, 4′ Stops

5 Clamping Lever

6 Cam (spiral)

7 Cylinder

8 Winding Shaft

9 First Axis

10 Second Axis

11 Device to Define a Rotary Axis

12 Point/axis of Rotation of the Clamping Disk

13 Link of the Piston to the Lever

14 Piston

15 Arrow

16 Arrow

17 Arrow

18 Arrow

19 Clamping Device

20 Arrow

21 Distance Between 13 and 10

22 Distance Horizontal Between 10 and 9

23 Circumference of the Cam 6

24 Distance Between the Circumference 23 of the Cam 6 and the Point/Axis of Rotation 12 of the Cam 6

F Direction of Influence of the Clamping Force Upon the Shaft 8

1. A device (19) for holding a shaft (8), preferably a winding shaft (8),
by which the shaft (8) can be fixated by the contacting of at least one body (3) in a recess (3),
characterized in that
a lever (5) is supported rotational about a first axis (9).

2. A device according to claim 1,
characterized in that
the first axis (9) is positioned displaceable in reference to the accept (3).

3. A device according to claim 1,
characterized in that
the first axis (9) extends parallel in reference to the holding position of the shaft (8).

4. A device according to claim 1,
characterized in that
a device (11) to define a second rotary axis (10), by which a second rotary axis (10) can be defined for the lever (5), as needed.

5. A device according to claim 4,
characterized in that
the device (11) comprises a cam (6) to define a second rotary axis (12).

6. A device according to claim 5,
characterized in that
the cam (6) in turn is pivotal about an axis (12).

7. A device according to claim 4,
characterized in that
a device (11) comprises a bore in the lever (5) in order to define a second rotary axis (10).

8. A device according to claim 1,
characterized in that
at least one stop (4, 4′) acts against the lever (5) in its operating motion.

9. A device according to claim 1,
characterized in that
at least one clamping claw (3), which can be impinged with a force via the lever (5) and by which (3) the shaft (8) can be fixated.

10. A device according to claim 1,
characterized in that
at least one cylinder (7), preferably a pneumatic cylinder.

11. A device according to claim 1,
characterized in that
a direction of transportation (1, 2) by which the first axis (9) can be moved in reference to the shaft (8).

12. A method for holding a shaft (8), preferably a winding shaft (8), in which the shaft (8) is fixated in an accept (3),
in which at least one body (3) contacts in the direction towards the shaft (8),
characterized in that
a lever (5), which is supported rotational about a first axis (9), is moved in reference to the shaft.

13. A method according to claim 12,
characterized in the sequence of the following processing steps:
rotary motion of the lever (5) about the first axis (9)
definition of the second axis (10)
rotary motion of the lever (5) about the second axis (10).

14. A method according to claim 13,
characterized in that
prior to the rotary motion of the lever (5) about the first axis (9) a motion occurs of the first axis (9) in the direction towards the shaft (8).

15. A method according to claim 14,
characterized in that
during the motion of the first axis (9) in the direction towards the shaft (8) at least one stop (4, 4′) and at least one clamping jaw (3) is entrained.
